(19) United States
(12) Patent Application Publication
(10) Pub. No.: US 2026/0120264 A1
(43) Pub. Date: Apr. 30, 2026

(54) METHOD OF DETECTING PROCESS RISKS BASED ON THREE-DIMENSIONAL OBJECT RECOGNITION, AND EDGE DEVICE THEREFOR

(71) Applicant: UX FACTORY CO., LTD., Seongnam-si (KR)

(72) Inventors: Jun Young PARK, Seongnam-si (KR); Ji Hye KIM, Seongnam-si (KR)

(21) Appl. No.: 18/954,064

(22) Filed: Nov. 20, 2024

(30) Foreign Application Priority Data
Oct. 31, 2024 (KR) 10-2024-0152840

(51) Int. Cl. G06T 7/00; G06T 7/80; G06V 10/70

(52) U.S. Cl. CPC G06T 7/0004; G06T 7/80; G06V 10/70

(57) ABSTRACT

Provided is a method of detecting process risks based on three-dimensional object recognition by an edge device, and an edge device therefor. The method may include: acquiring at least one two-dimensional (2D) image by capturing images of a process environment including at least one target object at different points, the 2D images including information on a location and direction of a camera that captures each of the 2D images; extracting the target object from at least one of the 2D images through a first network function and determining whether the target object is defective; generating 3D rendering information on the process environment based on the plurality of 2D images through a second network function; and generating volume information and location information of the target object determined to be defective based on the 3D rendering information.

### CROSS-REFERENCE TO RELATED APPLICATION

This application claims priority to and the benefit of Korean Patent Application No. 10-2024-0152840, filed on Oct. 31, 2024, the disclosure of which is incorporated herein by reference in its entirety.

### BACKGROUND

### 1. Field of the Invention

The present disclosure relates to a method of detecting process risks based on three-dimensional object recognition, and an edge device therefor.

### 2. Discussion of Related Art

Smart factories are intelligent factories designed to collect data throughout a manufacturing process based on the latest manufacturing automation technology and enable real-time monitoring and control based on the collected data. Such a system aims to maximize not only the efficiency of a process but also the safety by integrating various technologies such as IoT sensors, cameras, and artificial intelligence (AI)-based analysis. With the introduction of smart factories, factories may identify a status of each process in real time through data, which leads to improved product quality and production speed while providing benefits in terms of maintenance and risk management. In particular, data may support the optimization of production at each manufacturing stage of a factory, and maintain a safe and consistent operation while minimizing human intervention during the process.

However, there are several limitations in the existing technologies to recognize and respond to risk factors that may occur during the process in a timely manner. For example, it is still technically difficult for robots to autonomously recognize and quickly respond to defective products or obstacles that occur during the process. In the existing systems, robots may recognize locations and shapes of obstacles, but have limitations in accurately identifying volumes or structures of the obstacles. This makes immediate response difficult, especially in dynamic environments. For example, defective products or unexpected obstacles that suddenly appear on a container belt during the production process should be recognized quickly, but the existing technologies have limitations in identifying the sizes and shapes of obstacles in real time. These limitations act as major constraints in taking efficient and safe measures when robots perform obstacle removal operations.

Meanwhile, the existing systems for collecting process data and analyzing the collected process data within smart factories adopt a method of transmitting large-scale images to a central server for processing. However, this centralized method is limited by network bandwidth and causes various problems such as data transmission delays and slow processing speeds.

Accordingly, there is an increasing demand for new technologies that can quickly recognize and respond to risk factors that may occur in smart factories.

### SUMMARY OF THE INVENTION

The present disclosure provides a method of detecting process risks based on three-dimensional object recognition, and an edge device therefor.

According to an embodiment of the present disclosure, there is provided a method of detecting process risks based on three-dimensional object recognition by an edge device. The method may include: acquiring at least one two-dimensional (2D) image by capturing images of a process environment including at least one target object at different view points, the 2D images including information on a location and direction of a camera that captures each of the 2D images; extracting the target object from at least one of the 2D images through a first network function and determining whether the target object is defective; generating 3D rendering information on the process environment based on the plurality of 2D images through a second network function; and generating volume information and location information of the target object determined to be defective based on the 3D rendering information.

The determining of whether the target object is defective may include: extracting at least one bounding box corresponding to the target object from at least one of the 2D images through the first network function, the bounding box including information on a location, size, and predicted class of the bounding box; and comparing a normal object image corresponding to the predicted class of the above bounding box with the target object within the bounding box to determine whether the target object is defective.

The generating of the 3D rendering information on the process environment may include: generating information on 3D coordinates and a viewing direction for a plurality of 3D points based on information on the plurality of 2D images and locations and directions of cameras corresponding to each of the 2D images; inputting the information on the 3D coordinates and the viewing direction to the second network function and outputting opacity of a 3D point; and synthesizing the opacity of the plurality of 3D points to generate 3D rendering information corresponding to the process environment.

The second network function may be composed of a multi-layer perceptron network.

The method may further include transmitting a real-time processing signal for the target object determined to be defective based on the volume information and the location information to a task device.

The plurality of two-dimensional images may include high-resolution images captured by a global shutter operation.

According to another embodiment of the present disclosure, there is provided a computer program. The program may be stored on a recording medium for executing the method according to an embodiment of the present disclosure.

According to still another embodiment of the present disclosure, there is provided an edge device for detecting process risks based on 3D object recognition. The edge device includes: at least one processor; and a memory storing a program executable by the processor, in which the processor may execute the program to acquire at least one two-dimensional (2D) image by capturing images of a process environment including at least one target object at different view points, extract the target object from at least one of the 2D images through a first network function, determine whether the target object is defective, generate 3D rendering information on the process environment based on the plurality of 2D images through a second network function, and generate volume information and location information of the target object determined to be defective based on the 3D rendering information, and the 2D images may include information on a location and direction of a camera that captures each of the 2D images.

### BRIEF DESCRIPTION OF DRAWINGS

In order to more fully understand the drawings cited herein, a brief description of each drawing is provided:

FIG. 1 is a diagram for describing a system for detecting process risks based on three-dimensional object recognition according to an embodiment of the present disclosure;

FIG. 2 is a block diagram for describing a configuration of an edge device for detecting process risks based on three-dimensional object recognition according to an embodiment of the present disclosure;

FIG. 3 is a functional block diagram for describing an operation of a processor of the edge device according to an embodiment of the present disclosure;

FIG. 4 is a flowchart of a method of detecting process risks based on three-dimensional object recognition according to an embodiment of the present disclosure;

FIG. 5 is a flowchart for describing an embodiment of operation S420 of FIG. 4;

FIG. 6 is a flowchart for describing an embodiment of operation S430 of FIG. 4;

FIG. 7 is a diagram for describing a three-dimensional object recognition process according to an embodiment of the present disclosure; and

FIG. 8 is a diagram for exemplarily describing process risk detection based on three-dimensional object recognition of the present disclosure and its subsequent process.

### DETAILED DESCRIPTION OF EXEMPLARY EMBODIMENTS

However, the technical idea of the present disclosure may be variously modified and have several embodiments, and therefore, specific exemplary embodiments will be illustrated in the accompanying drawings and be described in detail. However, this is not intended to limit the technical idea of the present disclosure, which should be understood to include all modifications, equivalents or substitutes included in the scope of the technical idea of the present disclosure, to a specific embodiment.

In describing the technical idea of the present disclosure, if it is determined that detailed description of related known technology may unnecessarily obscure the gist of the present disclosure, the detailed description thereof will be omitted.

Terms used herein are used to describe embodiments, and are not intended to restrict and/or limit the present disclosure. Singular forms include plural forms unless the context clearly indicates otherwise. In addition, numbers (for example, first, second, etc.) used in the present specification are only identification symbols for distinguishing one component from other components.

When a part in the present specification is connected to another part, this includes not only cases where it is directly connected, but also cases where it is indirectly connected with another structure in between. Unless explicitly described to the contrary, the word “comprise,” and variations such as “comprises” or “comprising,” will be understood to imply the inclusion of stated elements but not the exclusion of any other elements.

In addition, the term “or” in the present disclosure is intended to mean an inclusive “or”, not an exclusive “or.” That is, unless otherwise specified or clear from context, “X uses A or B” is intended to mean one of the natural implicit substitutions. That is, “X uses A or B” may apply to any of these cases where X uses A; X uses B; or X uses both A and B. In addition, the term “and/or” used herein should be understood to refer to and include all possible combinations of one or more of the related components listed.

In addition, terms such as “unit,” “device,” “-or/-er,” and “module” described in the present disclosure mean a unit that processes at least one function or operation. This can be implemented by hardware such as a processor, a microprocessor, a microcontroller, a central processing unit (CPU), a graphics processing unit (GPU), an accelerate processor unit (APU), a digital signal processor (DSP), an application specific integrated circuit (ASIC), a field programmable gate array (FPGA), software, or a combination of hardware and software.

It is to be noted that components in the present disclosure are merely divided based on main functions that each component is responsible for. That is, two or more components to be described below may be combined into one component, or one component may be divided into two or more for each subdivided function. In addition, each of the constituent parts to be described below may additionally perform some or all of the functions of other constituent parts in addition to the main functions of the constituent parts, and some of the main functions of the constituent parts may be performed exclusively by other components.

A method according to an embodiment of the present disclosure may be performed on a personal computer, workstation, server computer device, etc., equipped with computing capabilities, or may be performed on a separate device for this purpose.

In addition, the method may be performed on one or more computing devices. For example, at least one or more operations of the method according to an embodiment of the present disclosure may be performed on a client device, and other operations may be performed on a server device. In this case, the client device and the server device may be connected to a network to transmit and receive computing results. Alternatively, the method may be performed by distributed computing technology.

In this specification, an artificial intelligence learning model may be used with the same meaning as an artificial intelligence model, a computational model, a machine learning model, etc. The artificial intelligence learning model may be trained by various algorithms, such as a decision tree, a random forest, Gaussian naive Bayes, k-nearest neighbor, ada boost, a support vector machine, voting, bagging, a neural network, and deep learning. However, the present disclosure is not limited thereto.

The artificial intelligence learning model may be trained in at least one of supervised learning, unsupervised learning, semi-supervised learning, or reinforcement learning. The training of the artificial intelligence learning model may be a process of applying knowledge for the model to perform a specific operation to the model. When an algorithm such as a neural network or deep learning is applied to the artificial intelligence learning model, the artificial intelligence learning model may be referred to as a network function. The network function may be used with the same sense as a neural network. The neural network may generally be composed of a set of interconnected computational units, which may be referred to as nodes. These “nodes” may also be referred to as “neurons.” The neural network is composed of at least one node, and the nodes may be interconnected by one or more links.

The neural network may include a deep neural network (DNN). The deep neural network may include a convolutional neural network (CNN), a recurrent neural network (RNN), an auto encoder, a restricted Boltzmann machine (RBM), a deep belief network (DBN), a Q network, a U network, a Siamese network, a generative adversarial network (GAN), etc. However, the present disclosure is not limited thereto.

Hereinafter, embodiments of the present disclosure will be described in detail in order.

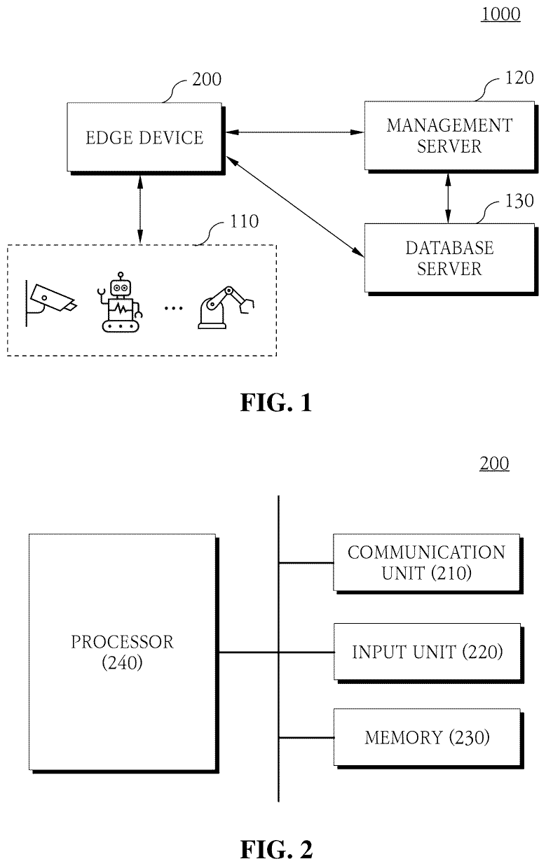

FIG. 1 is a diagram for explaining a system for detecting process risks based on three-dimensional (3D) object recognition according to an embodiment of the present disclosure.

As illustrated in FIG. 1, a system 1000 for detecting process risks may include a plurality of task devices 110, a management server 120, a database server 130, and an edge device 200.

The plurality of task devices 110 may be disposed in a process environment, such as a factory or a smart factory, to monitor a process situation and perform at least one task for process processing or accident prevention/preparation according to a control signal of the edge device 200 and/or the management server 120. In an embodiment, the plurality of task devices 110 may include, but are not limited to, a camera device, a robot arm, a mobile robot device, etc., and various components may be applied.

For example, the camera device may capture images of a process environment including at least one target object from a plurality of viewpoints or angles to generate at least one two-dimensional image. Here, the target object may include various objects, which may exist in the process environment, such as a target object of a task, an intermediate product, an obstacle, and a person. For this purpose, the camera device is configured in a plurality and may be installed in various locations required for each process.

In an embodiment, the camera device may be configured to generate a high-resolution two-dimensional (2D) image through a global shutter operation method. The global shutter operation method may include exposing all pixels of a sensor to light at once, unlike a standard rolling shutter technology, to produce more accurate and sharper images. In particular, the global shutter operation method may prevent distortion of a moving object image to prevent the degradation of detection performance of the edge device 200 due to process risks.

The management server 120 may communicate with at least one edge device 200 installed in the process environment and transmit and receive various signals or data. For example, the management server 120 may receive processing results (a processed image or video) for risk situations (such as the occurrence of defects, failures, etc.) in the process environment from the edge device 200.

The database server 130 may store information (a real-time video, a video of the occurrence of a defect, failure, etc., a video of processing defects, failures, etc.) transmitted from the management server 120, the edge device 200, and/or the camera device, or search for and transmit requested information in response to a request from the management server 120 and/or the edge device 200.

The edge device 200 is provided in response to an individual process environment such as a factory or a smart factory, and may detect whether a risk (such as defects, failures, etc.) occurs in the process environment based on an artificial intelligence technology, and control the task device 110 to perform real-time measures for such defects, failures, etc. For example, the edge device 200 may detect whether the defects, failures, etc., occur in the process environment based on the 2D image captured by the camera device, and also generate 3D rendering information on the process environment using the 2D image. Then, the edge device 200 may generate information on a volume and location of a target object in which the defects, failures, etc., occur based on the 3D rendering information, and transmit a control signal including the generated information to the task device 110 such as a robot arm and/or a mobile robot device, thereby performing real-time measures for the defects or failures. The edge device 200 includes all types of computing devices such as smartphones, smart pads, tablet personal computers (tablet PCs), desktops, and laptops, and may further include IoT terminals, embedded boards, etc., that operate in an embedded environment. In addition, in the embodiment, the edge device 200 may be integrally implemented with at least one of the task devices 110.

In the present disclosure, by performing the detection and processing of risks (defects or failures) based on artificial intelligence at an edge (i.e., the edge device 200) and only selectively transmitting necessary information to the management server 120, the real-time processing of risk factors can be performed more quickly.

The configuration of the system 1000 illustrated in FIG. 1 is exemplary, and various configurations may be applied according to an embodiment of the present disclosure.

FIG. 2 is a block diagram for describing a configuration of an edge device for detecting process risks based on 3D object recognition according to an embodiment of the present disclosure.

Referring to FIG. 2, the edge device 200 may include a communication unit 210, an input unit 220, a memory 230, and a processor 240. In an embodiment, each configuration of the edge device 200 may be mounted on a moving object such as a vehicle.

The communication unit 210 may receive or transmit internal or external data. The communication unit 210 may include a wired or wireless communication unit. When the communication unit 210 includes a wired communication unit, the communication unit 210 may include one or more components that enable communication through a local area network (LAN), a wide area network (WAN), a value added network (VAN), a mobile radio communication network, a satellite communication network, and a combination thereof. In addition, when the communication unit 210 includes a wireless communication unit, the communication unit 210 may wirelessly transmit and receive data or signals using cellular communication, a wireless LAN (e.g., Wi-Fi), etc. In an embodiment, the communication unit 210 may transmit and receive data or signals to and from an external device or an external server under the control of the processor 240.

The input unit 220 may receive various user commands through external manipulation. For this purpose, the input unit 220 may include or be connected to one or more input devices. For example, the input unit 220 may be connected to interfaces for various inputs such as a keypad and a mouse to receive user commands. For this purpose, the input unit 220 may include not only a USB port but also an interface such as Thunderbolt. In addition, the input unit 220 may include various input devices such as a touch screen and a button or be coupled to these input devices to receive external user commands.

The memory 230 may store programs and/or program commands for the operation of the processor 240 and may temporarily or permanently store input/output data. The memory 230 may include at least one type of storage medium such as a flash memory type, a hard disk type, a multimedia card micro type, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

In addition, the memory 230 may store various network functions, artificial intelligence learning models and/or algorithms, and store various data, programs (one or more instructions), applications, software, commands, codes, etc. for driving and controlling the edge device 200.

In an embodiment, the memory 230 may store various data and programs for detecting process risks based on 3D object recognition according to the process presented below by the processor 240 to be described below.

The processor 240 may control all or at least a part of the operation of the edge device 200. The processor 240 may execute one or more programs or software stored in the memory 230. The processor 240 may be the dedicated processor 240, on which the methods according to an embodiment of the present disclosure are performed, such as a central processing unit (CPU), a graphics processing unit (GPU), or a field programmable gate array (FPGA).

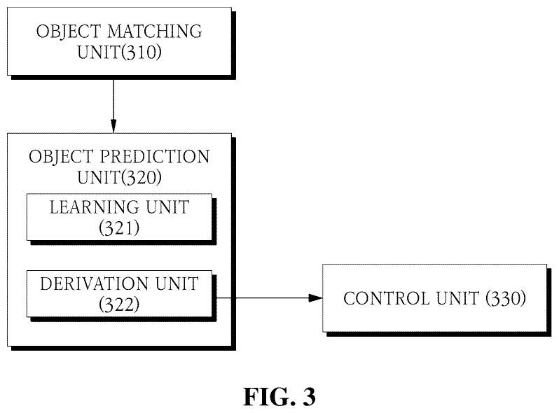

In an embodiment, the processor 240 may perform functions of an object matching unit 310, an object prediction unit 320, and a control unit 330, as illustrated in FIG. 3, by executing the programs, network functions, and/or algorithms stored in the memory 230.

In an embodiment, the processor 240 may acquire at least one 2D image by capturing images of a process environment including at least one target object at different view points, extract a target object from at least one of the 2D images through a first network function, determine whether the target object is defective, generate 3D rendering information on the process environment based on a plurality of 2D images through a second network function, and generate volume information and location information of the target object determined to be defective based on the 3D rendering information. Here, each of the 2D images may include information on a location and direction of a camera that captures each of the images.

In an embodiment, the processor 240 may extract at least one bounding box corresponding to a target object from at least one of the 2D images through the first network function, and compare a normal object image corresponding to a predicted class of the bounding box with the target object in the bounding box to determine whether the target object is defective. Here, the bounding box may include information on the location, size, and predicted class of the bounding box.

In an embodiment, the processor 240 may generate information on 3D coordinates and viewing directions for a plurality of 3D points based on a plurality of 2D images and information on the locations and directions of cameras corresponding to each of the 2D images, input the information on the 3D coordinates and viewing directions to a second network function to output opacities of the 3D points, and synthesize the opacities of the plurality of 3D points to generate the 3D rendering information corresponding to the process environment.

In an embodiment, the processor 240 may transmit a real-time processing signal for a target object determined to be defective based on volume information and location information to the task device.

The configuration of the edge device 200 illustrated in FIG. 2 is exemplary, and various configurations may be applied according to an embodiment of the present disclosure.

FIG. 3 is a functional block diagram for describing an operation of the processor of the edge device according to an embodiment of the present disclosure.

The configuration illustrated in FIG. 3 may be implemented by allowing the processor 240 of the edge device 200 to execute at least one program, network function, and/or algorithm stored in the memory 230.

The object matching unit 310 may extract a target object from at least one 2D image obtained by capturing images of a process environment including at least one target object at different view points, and determine whether the target object is defective.

To this end, the object matching unit 310 may include at least one first network function. In an embodiment, the first network function may be an artificial intelligence learning model for object detection trained to detect a target object from an image. For example, the first network function may be a You Only Look Once (YOLO) algorithm model implemented to enable simultaneous detection of a plurality of target objects, but is not limited thereto, and various artificial intelligence learning models or algorithms based on a convolutional neural network (CNN) may be applied.

In the embodiment, the object matching unit 310 may detect the target object from the 2D image using the bounding box. For example, an area in which the target object is highly likely to exist in the 2D image may be detected through the bounding box. In this case, the target object may be composed of at least one type, and different classes may be defined for each type of target object. Accordingly, each bounding box may include information about a location (i.e., center coordinates) and size (i.e., width and height) of the bounding box and the predicted class (i.e., class and probability thereof) corresponding to the detected target object.

The object matching unit 310 may determine whether the target object is defective using a normal object image corresponding to each target object. The normal object image may be stored in the memory 230 of the edge device 200 and/or the database server 130, and may be transmitted according to the request of the object matching unit 310. For example, the object matching unit 310 may acquire a normal object image corresponding to the predicted class of the bounding box, and compare the acquired normal object image with the target object in the bounding box to determine whether the target object is defective.

The object prediction unit 320 may generate 3D rendering information or a 3D rendering image corresponding to the process environment through the plurality of 2D images of different view points, and generate the volume information and location information of the target object where the defect has occurred based on the 3D rendering information or the 3D rendering image. In an embodiment, the object prediction unit 320 may include a learning unit 321 and a derivation unit 322.

The learning unit 321 may generate the 3D rendering information or the 3D rendering image corresponding to the process environment through the plurality of 2D images.

In an embodiment, the generation of the 3D rendering information or the 3D rendering image of the learning unit 321 may be performed through a neural radiance fields (NeRF) technology. To this end, the learning unit 321 may include a second network function that is configured as a multi-layer perceptron network.

For example, the learning unit 321 may generate information on 3D coordinates and viewing directions for a plurality of 3D points based on information on a plurality of 2D images and locations and directions of cameras corresponding to each of the 2D images. Specifically, the learning unit 321 may fire rays from a center of a camera of a virtual view to be newly generated toward an object and sample a plurality of 3D points on the rays to generate information on 3D coordinates and viewing directions for the plurality of 3D points. In addition, the learning unit 321 may input the information on the 3D coordinates and viewing direction to the second network function to output colors and opacities (or densities) of the 3D points, and synthesize the colors and/or opacities of the plurality of 3D points to generate the 3D rendering information or the 3D rendering image corresponding to the process environment.

The derivation unit 322 may generate the volume and location information of the target object determined to be defective in the process environment based on the generated 3D rendering information or 3D rendering image. For example, the derivation unit 322 may model a 3D scene of the process environment based on the 3D rendering information, and calculate the volume and location of the target object based on the modeled 3D scene.

In an embodiment, the derivation unit 322 may optimize the target object for which the color and/or opacity have been calculated to derive a final result value. For example, an optimization method such as positional encoding or hierarchical sampling may be applied.

The control unit 330 may manage and control the task device 110, such as a robot arm and a mobile robot device, disposed in the process environment. In particular, the control unit 330 may generate a control signal for processing the defective target object based on the volume and location information of the defective target object received from the derivation unit 322, and transmit the generated control signal to the task devices 110 such as the robot arm and the mobile robot device, thereby processing the risk of the process environment in real time.

The functional configuration illustrated in FIG. 3 is exemplary, and various configurations may be applied according to an embodiment of the present disclosure.

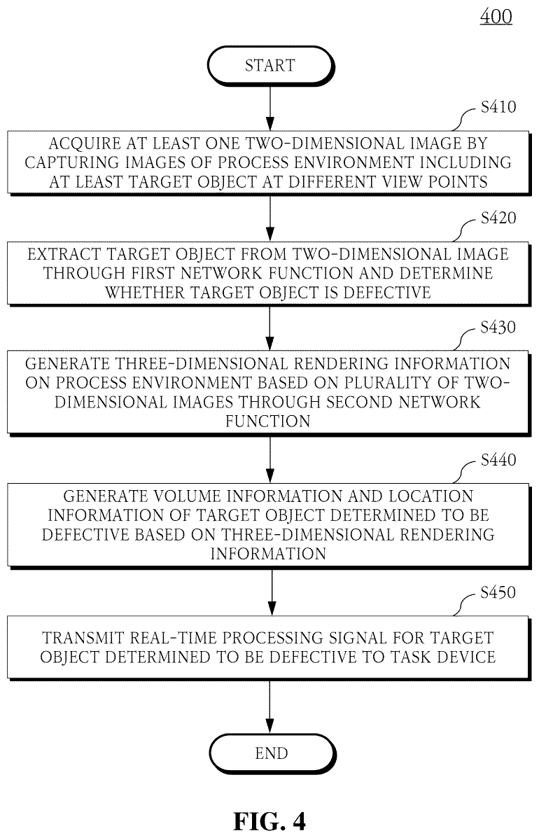

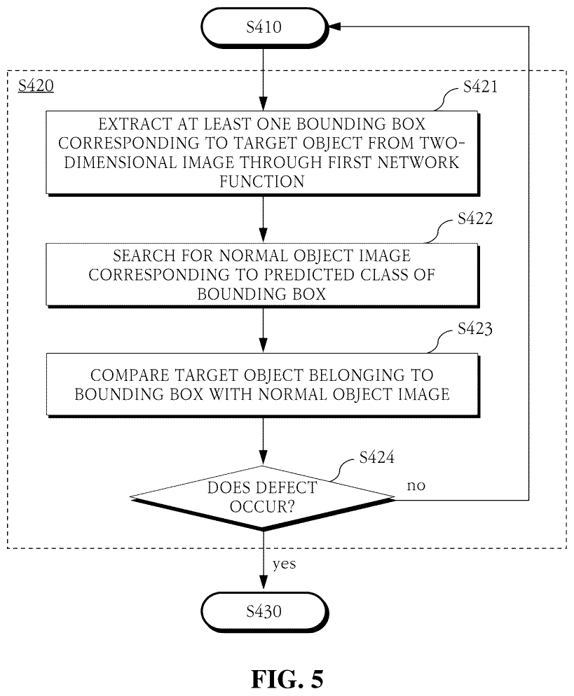

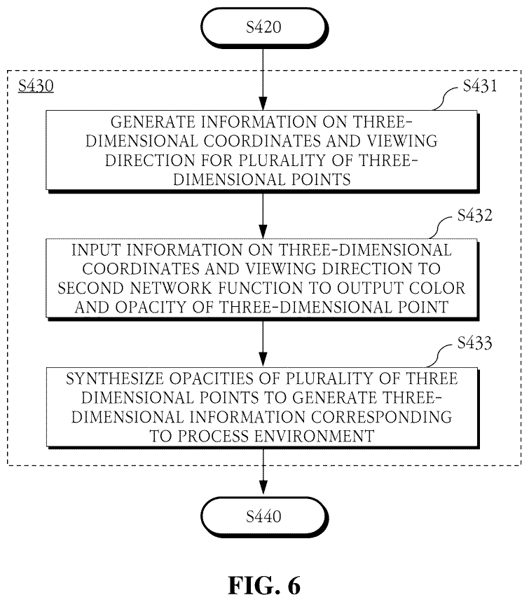

FIG. 4 is a flowchart of a method of detecting process risks based on 3D object recognition according to an embodiment of the present disclosure, FIG. 5 is a flowchart for describing an embodiment of operation S420 of FIG. 4, and FIG. 6 is a flowchart for describing an embodiment of operation S430 of FIG. 4.

In operation S410, the edge device 200 may acquire at least one 2D image obtained by capturing images of a process environment including at least one target object at different view points from at least one camera device.

Here, each of the 2D images may include information on a location and direction of a camera that captures each of the images. In addition, in an embodiment, the 2D image may be a high-resolution image captured through the global shutter operation method.

In addition, here, the process environment may be an area where various processes, such as processing, molding, packaging, sorting, and transportation of products, are performed in a factory, a smart factory, etc. The target object may include various objects that may exist within the process environment, such as a target of a task, an intermediate product, an obstacle, and a person. In an embodiment, the target object is composed of at least one type, and different classes may be defined for each type of target object in order to detect the target object through operation S420.

In operation S420, the edge device 200 may extract the target object from at least one of the 2D images through the first network function, and determine whether the target object is defective in real time.

In an embodiment, the first network function may be the artificial intelligence learning model for object detection trained to detect the target object from the image. For example, the first network function may be the You Only Look Once (YOLO) algorithm model implemented to enable the simultaneous detection of the plurality of target objects, but is not limited thereto, and various artificial intelligence learning models or algorithms based on the CNN may be applied.

As illustrated in FIG. 5, operation S420 may include operations S421 to S424.

In operation S421, the edge device 200 may extract at least one bounding box corresponding to the target object from at least one of the 2D images through the first network function.

Here, the bounding box is for partitioning an area where the target object is highly likely to exist among the 2D images based on the features of the target object, and each bounding box may include the information on the location (i.e., center coordinates) and size (i.e., width and height) of the bounding box and the predicted class (i.e., class and probability thereof) corresponding to the detected target object.

Next, in operation S422, the edge device 200 may search for a normal object image corresponding to the predicted class of each detected bounding box.

For example, the edge device 200 may search for the image corresponding to the predicted class among the plurality of normal object images stored in the memory 230, or transmit the predicted class information to the database server 130 to receive the corresponding normal object image.

Next, in operations S423 and S424, the edge device 200 may compare the normal object image corresponding to the predicted class of the bounding box with the target object in the bounding box to determine whether the target object is defective.

When the target object is determined to be defective, the process proceeds to operation S430, and when there is no target object determined to be defective, the process proceeds to operation S410 to acquire a new 2D image.

In operation S430, the edge device 200 may generate the 3D rendering information on the process environment based on the plurality of 2D images through the second network function.

In an embodiment, operation S430 may be performed by the NeRF algorithm. The NeRF considers a scene as a large number of 3D points distributed within a certain space, and trains the emissivities (colors) and densities (opacities) of each point. That is, by calculating the emissivities and densities at all points within the 3D space, the scene may be expressed as if the scene were composed of a continuous volume. The process by which light is being reflected and absorbed as light passes through each point within this volume field is numerically calculated so that a realistic 3D image may be generated when the scene is rendered from a new viewpoint.

To this end, the second network function is composed of the multi-layer perceptron network.

As illustrated in FIG. 6, operation S430 may include operations S431 to S433.

In operation S431, the edge device 200 may generate the information (i.e., the location information and direction information of the 3D points) on the 3D coordinates and viewing directions for the plurality of 3D points based on the plurality of 2D images and the information on the locations and directions of the cameras corresponding to each of the 2D images.

In an embodiment, the edge device 200 may fire rays from the center of the camera of the virtual view to be newly generated toward the target object and sample several points on the rays to generate the information on the 3D coordinates and viewing directions for the 3D points.

Subsequently, in operation S432, the edge device 200 may input the information on the 3D coordinates and viewing directions to the second network function, which is the multi-layer perceptron, to perform training, thereby outputting the colors and opacities (densities) of each 3D point.

Meanwhile, in the present disclosure, since only the volume of the target object needs to be calculated, in an embodiment, in operation S432, the edge device 200 may be configured to output only the opacity of the 3D point.

Next, in operation S433, the edge device 200 may synthesize the colors and/or opacities of the plurality of 3D points to generate the 3D rendering information corresponding to the process environment. For example, the 3D rendering information may include information on a final color and/or opacity optimized by applying an optimization method such as positional encoding and hierarchical sampling, or information on the 3D rendering image itself generated based on the information.

In operation S440, the edge device 200 may generate the volume information and location information of the target object determined to be defective based on the 3D rendering information.

For example, the edge device 200 may model the 3D scene of the process environment based on the 3D rendering information and calculate the volume and location of the target object based on the model, thereby generating the volume information and location information of the target object determined to be defective.

In step S450, the edge device 200 may generate the real-time processing signal for the target object determined to be defective based on the volume information and location information, and transmit the real-time processing signal to the task device.

For example, the real-time processing signal may be transmitted to the robot arm or the mobile robot device to remove defective products or avoid obstacles within the process environment.

In this case, the real-time processing signal may include the volume information and location information of the target object to be processed.

The method 400 illustrated in FIG. 4 is exemplary, and various configurations may be applied according to an embodiment of the present disclosure.

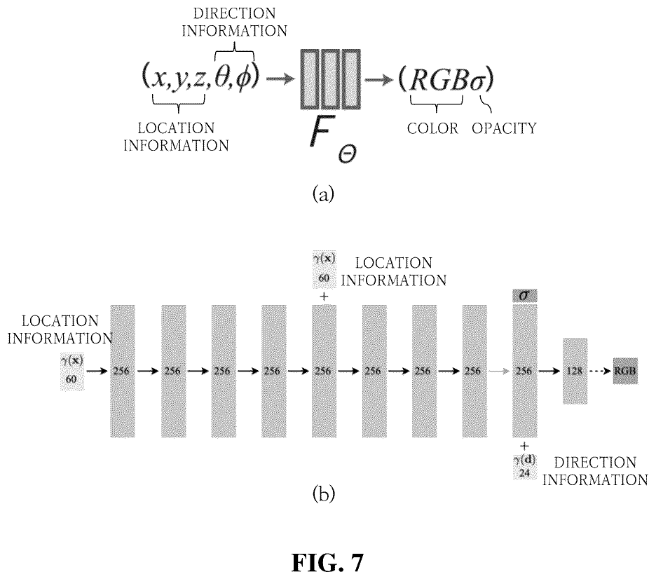

FIG. 7 is a diagram for describing a 3D object recognition process according to an embodiment of the present disclosure.

Referring to FIG. 7, the recognition of the 3D target object may be performed through the NeRF algorithm.

As illustrated in FIG. 7(a), the NeRF may input location information (x, y, z) and direction information (θ, φ) of the plurality of 3D points to the multi-layer perceptron network to perform the training, and output the colors (RGB) and opacities (density (σ)) at each 3D point (i.e., 3D coordinate).

Referring to FIG. 7(b), the multi-layer perceptron network may be composed of, for example, 10 layers. First, the location information may be transmitted from an input stage to a fifth layer, and the location information may be input once more in the fifth layer. This is a kind of skip connection method that merges input information back into an intermediate layer, allowing the neural network to continue training in a deeper layer while maintaining the initial input information. With this method, training can be performed efficiently, and in particular, complex 3D structures can be better reproduced.

Next, in a ninth layer, the opacity (density) may be output and the direction information may be input back to an opacity value, so that the predicted color (RGB) may be output finally.

As described above, since the purpose of the present disclosure is to obtain the volume information of the target object, only the opacity may be used without outputting the information on color.

The configuration illustrated in FIG. 7 is exemplary, and various configurations may be applied according to an embodiment of the present disclosure.

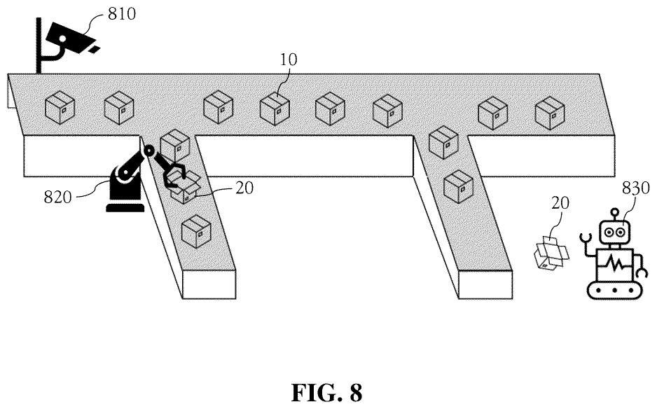

FIG. 8 is a diagram for exemplarily describing the process risk detection based on 3D object recognition of the present disclosure and its subsequent process.

Referring to FIG. 8, the process environment may be the environment in which the conveyor process for transporting or inspecting the target object 10 is performed.

A plurality of camera devices 810 may be installed around a conveyor belt to capture images of a target object from various angles, and a robot arm 820 and a mobile robot device 830 for processing defective products 20 or obstacles may be disposed.

The edge device 200 may receive 2D images of multiple viewpoints from the camera device 810, and determine whether the target object 10 is defective or whether obstacles occur based on the received 2D images. When it is determined that there are the defective products 20 or obstacles, the edge device 200 models (or renders) the 3D scene based on the 2D images, and calculates the volumes and locations of the defective products 20 or the obstacles. Subsequently, the edge device 200 may generate the real-time processing signal based on the volumes and locations of the defective products 20 or the obstacles, and transmit the generated real-time processing signal to the robot arm 820 and the mobile robot device 830, thereby controlling the robot arm 820 to remove the defective products 20 or avoid the obstacles.

The methods according to the embodiment of the present disclosure may be implemented in the form of program commands that may be executed through various computer means and may be recorded in a computer-readable recording medium. The computer-readable recording medium may include program commands, data files, data structures or the like, alone or in combination. The program commands recorded in the computer-readable recording medium may be specially designed and configured for the present disclosure or be known to those skilled in a field of computer software. Examples of the computer-readable recording medium may include a magnetic medium such as a hard disk, a floppy disk, or a magnetic tape; an optical medium such as a CD-ROM or a DVD; a magneto-optical medium such as a floptical disk; and a hardware device specially configured to store and execute program commands, such as a ROM, a random access memory (RAM), a flash memory, or the like. Examples of the program commands include high-level language codes capable of being executed by a computer using an interpreter, or the like, as well as machine language codes made by a compiler.

In addition, the methods according to various disclosed embodiments may be included and provided in a computer program product. The computer program product may be traded as a product between a seller and a purchaser.

A computer program product may include an S/W program and a computer-readable storage medium on which the S/W program is stored. For example, the computer program product may include a product (e.g., a downloadable app) in the form of an S/W program distributed electronically by a manufacturer of an electronic device or through an electronic market (e.g., Google Play Store, App Store). For electronic distribution, at least a part of the S/W program may be stored in a storage medium or temporarily generated. In this case, the storage medium may be a storage medium of a server of a manufacturer, a server of an electronic market, or a relay server that temporarily stores the SW program.

In a system including a server and a client device, the computer program product may include the storage medium of the server or the storage medium of the client device. Alternatively, when there is a third device (e.g., a smartphone) that communicates with the server or the client device, the computer program product may include the storage medium of the third device. Alternatively, the computer program product may include the S/W program itself that is transmitted from the server to the client device or the third device, or transmitted from the third device to the client device.

In this case, one of the server, the client device, and the third device may execute the computer program product to perform the method according to the disclosed embodiments. Alternatively, two or more of the server, the client device, and the third device may execute the computer program product to perform the method according to the disclosed embodiments in a distributed manner.

For example, a server (e.g., a cloud server or an artificial intelligence server, etc.) may execute the computer program product stored on the server to control the client device connected to the server to perform the method according to the disclosed embodiments.

According to embodiments of the present disclosure, by providing a system capable of accurately detecting defective conditions or risk factors in real time during the process and immediately taking automatic measures, it is possible to increase the stability of the process and quickly resolve problems without the intervention of workers.

According to embodiments of the present disclosure, AI processing is performed at an edge, enabling rapid interaction between a site and a server, and in particular, since processed image information is transmitted to a server only when necessary, it is possible to reduce data transmission costs and network loads, and realize rapid intelligent decision.

According to embodiments of the present disclosure, by predicting defects or sizes of obstacles in a three-dimensional space and supporting robots to automatically remove the obstacles, it is possible to secure work efficiency and safety at the same time.

Effects which can be achieved by embodiments of the present disclosure are not limited to the above-described effects. That is, other objects that are not described may be obviously understood by those skilled in the art to which the present disclosure pertains from the following description.

Although the embodiments have been described in detail above, the scope of the rights of the present disclosure is not limited thereto, and various modifications and improvements made by those skilled in the art using the basic concept of the present disclosure defined in the following claims also fall within the scope of the rights of the present disclosure.

1. A method of detecting process risks based on three-dimensional (3D) object recognition by an edge device, the method comprising:
acquiring at least one two-dimensional (2D) image by capturing images of a process environment including at least one target object at different view points, the at least one 2D image including information on a location and direction of a camera that captures each of the at least one 2D image;
extracting the at least one target object from the at least one 2D image through a first network function and determining whether the at least one target object is defective;
generating 3D rendering information on the process environment based on a plurality of 2D images through a second network function; and
generating volume information and location information of the at least one target object determined to be defective based on the 3D rendering information.

2. The method of claim 1, wherein the determining of whether the at least one target object is defective comprises:
extracting at least one bounding box corresponding to the at least target object from the at least one 2D image through the first network function, the at least one bounding box including information on a location, size, and predicted class of the at least one bounding box; and
comparing a normal object image corresponding to the predicted class of the at least one bounding box with the at least one target object within the at least one bounding box to determine whether the at least one target object is defective.

3. The method of claim 1, wherein the generating of the 3D rendering information on the process environment comprises:
generating information on 3D coordinates and a viewing direction for a plurality of 3D points based on information on the plurality of 2D images and locations and directions of cameras corresponding to each of the plurality of 2D images;
inputting the information on the 3D coordinates and the viewing direction to the second network function and outputting opacity of the plurality of 3D points; and
synthesizing the opacity of the plurality of 3D points to generate the 3D rendering information corresponding to the process environment.

4. The method of claim 3, wherein the second network function is composed of a multi-layer perceptron network.

5. The method of claim 1, further comprising transmitting to a task device a real-time processing signal for the at least one target object determined to be defective based on the volume information and the location information.

6. The method of claim 1, wherein the plurality of 2D images include high-resolution images captured by a global shutter operation.

7. A computer program stored on a non-transitory recording medium for executing the method according to claim 1.

8. An edge device for detecting process risks based on 3D object recognition, the edge device comprising:
at least one processor; and
a memory configured to store a program executable by the processor,
wherein the processor executes the program and is configured to:
acquire at least one two-dimensional (2D) image by capturing images of a process environment including at least one target object at different view points;
extract the at least one target object from the at least one 2D image through a first network function;
determine whether the at least target object is defective;
generate 3D rendering information on the process environment based on a plurality of 2D images through a second network function; and
generate volume information and location information of the at least one target object determined to be defective based on the 3D rendering information, and
wherein each of the plurality of 2D images includes information on a location and direction of a camera that captures the at least one 2D image.
